(19) United States
(12) Patent Application Publication
(10) Pub. No.: US 2017/0075316 A1
(43) Pub. Date: Mar. 16, 2017

(54) Smart Watch with Power Saving Timekeeping Only Functionality and Methods Therefor

(71) Applicant: Motorola Mobility LLC, Chicago, IL (US)

(72) Inventors: Eric Berdinis, Chicago, IL (US); Shakil Barkat, Gurnee, IL (US); Ricky J. Hoobler, Lake Bluff, IL (US)

(21) Appl. No.: 14/851,431

(22) Filed: Sep. 11, 2015

(51) Int. Cl. G04G 19/06; G04G 21/00; G04G 9/00

(52) U.S. Cl. CPC G04G 19/06; G04G 9/0064; G04G 21/00

(57) ABSTRACT

A smart watch includes a watch casing with a display disposed along the watch casing. One or more processors are operable with the display. An energy storage device powers the one or more processors. When an amount of stored energy in the energy storage device is above a predefined threshold, the one or more processors perform a timekeeping function and at least one additional function. When the amount of stored energy in the energy storage device falls below the predefined threshold, the one or more processors disable the at least one additional function while continuing to perform the timekeeping function.

### BACKGROUND

Technical Field

This disclosure relates generally to electronic devices, and more particularly to wearable electronic devices.

Background Art

Mobile electronic communication devices, such as mobile telephones, smart phones, gaming devices, and the like, are used by billions of people. These owners use mobile communication devices for many different purposes including, but not limited to, voice communications and data communications for text messaging, Internet browsing, commerce such as banking, and social networking. As the technology of these devices has advanced, so too has their feature set. For example, not too long ago the only way to deliver user input to a device was with touch, either through a keypad or touch sensitive display. Today some devices are equipped with voice recognition that allows a user to speak commands to a device instead of typing them.

In addition to being able to provide more features, the devices are also getting smaller. While most wireless communication devices used to be handheld, development of wearable devices has lead to a wearable computer known as a “smart watch.” Smart watches offer added conveniences in comparison to smart phones or tablet computers due to the fact that they can be conveniently worn on the wrist. Smart watches incorporate numerous feature sets. For example, they can maintain calendars, send and receive text and multimedia messages, work cooperatively with a mobile telephone to make and receive calls, obtain stock quotations, and so forth.

These smaller, yet more powerful, devices are being used for many different applications in many different environments. While they offer more features, they also consume far more current than do conventional electronic watches. The smaller device size limits the size of the battery it can contain. Illustrating by example, most smart watches today have batteries with a capacity of about 350 mAh. Such batteries generally provide only one day of full-feature performance. It would be advantageous to have increased methods to control operating modes of a smart watch to extend the life of the battery.

### BRIEF DESCRIPTION OF THE DRAWINGS

FIG. 1 illustrates a schematic block diagram of one explanatory smart watch in accordance with one or more embodiments of the disclosure.

FIG. 2 illustrates some illustrative features offered by a smart watch in accordance with one or more embodiments of the disclosure.

FIG. 3 illustrates one explanatory smart watch operating in a normal mode of operation in accordance with one or more embodiments of the disclosure.

FIG. 4 illustrates one or more processors of an explanatory smart watch, when an amount of stored energy in the energy storage device of the smart watch falls below a predefined threshold, disabling one or more additional functions while continuing to perform a timekeeping function.

FIG. 5 illustrates another explanatory smart watch operating in a normal mode of operation in accordance with one or more embodiments of the disclosure.

FIG. 6 illustrates one or more processors of an explanatory smart watch, when an amount of stored energy in the energy storage device of the smart watch falls below a predefined threshold, disabling some additional functions while continuing to perform a timekeeping function and some other functions.

FIG. 7 illustrates yet another explanatory smart watch operating in a normal mode of operation in accordance with one or more embodiments of the disclosure.

FIG. 8 illustrates one or more processors of an explanatory smart watch, when an amount of stored energy in the energy storage device of the smart watch falls below a predefined threshold, disabling one or more additional functions by placing an application processor into a sleep mode and while continuing to perform a timekeeping function.

FIG. 9 illustrates still another explanatory smart watch operating in a normal mode of operation in accordance with one or more embodiments of the disclosure.

FIG. 10 illustrates one or more processors of an explanatory smart watch, when an amount of stored energy in the energy storage device of the smart watch falls below a predefined threshold, disabling one or more additional functions by switching operating systems and while continuing to perform a timekeeping function.

FIG. 11 illustrates one explanatory method for a smart watch in accordance with one or more embodiments of the disclosure.

FIG. 12 illustrates operating mode election in one explanatory smart watch in accordance with one or more embodiments of the disclosure.

FIG. 13 illustrates one explanatory smart watch in accordance with one or more embodiments of the disclosure.

FIG. 14 illustrates one explanatory method in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to reducing power consumption and extending operating run time in a smart watch. Process descriptions or blocks in a flow chart can be modules, segments, or portions of code that implement specific logical functions of a machine or steps in a process, or alternatively that transition specific hardware components into different states or modes of operation. Alternate implementations are included, and it will be clear that functions may be executed out of order from that shown or discussed, including substantially concurrently or in reverse order, depending on the functionality involved.

It will be appreciated that embodiments of the disclosure described herein may be comprised of one or more conventional processors and unique stored program instructions that control the one or more processors to implement, in conjunction with certain non-processor circuits, some, most, or all of the functions of reducing power consumption and extending operating run time in a smart watch. The non-processor circuits may include, but are not limited to, microphones, loudspeakers, acoustic amplifiers, digital to analog converters, signal drivers, clock circuits, power source circuits, and user input devices. As such, these functions may be interpreted as steps of a method to perform the reduction of power consumption and extension of operating run time in a smart watch. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to a smart watch, improve the functioning of the device itself by reducing power consumption, extending run time, and improving the overall user experience to overcome problems specifically arising in the realm of the technology associated with present day smart watch performance.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. As used herein, components may be “operatively coupled” when information can be sent between such components, even though there may be one or more intermediate or intervening components between, or along the connection path. Also, reference designators shown herein in parenthesis indicate components shown in a figure other than the one in discussion. For example, talking about a device (10) while discussing figure A would refer to an element, 10, shown in figure other than figure A.

Conventional watches can generally be categorized as either mechanical or electric. Mechanical watches can be either winders, where a user must manually wind the watch every day, or automatic, where motions of the wearer's arm are used to wind a mainspring. Automatic watches have the advantage of appearing to run, at least when worn daily, indefinitely without winding.

Electronic watches draw power from an on-board battery to power electronic circuits that perform a timekeeping function. A typical electronic watch might use a “coin” cell battery that stores roughly 150 mAh of energy. Current drain in these watches is incredibly low. A conventional electronic watch can run for many years on a single cell's charge. This is despite the fact that such watches provide multiple functions, including the timekeeping function in multiple time zones, day/date functions, stopwatch functions, timer functions, and alarm functions. Electronic watches with solar or ergonomic charging mechanisms can run for decades providing these functions.

By contrast, modern smart watches are greedy current consumers. As noted above, a typical smart watch may include a 350 mAh battery. However, a single cell's charge may only last one day. This decreased run time is due to the fact that, in addition to providing the functions of the electronic watch set forth above, smart watches offer a bright, color, touch-sensitive display. Smart watches also include wireless communication capability. Smart watches offer complex processors that are able to run animated applications smoothly and seamlessly. Finally, smart watches have the processing prowess to run numerous applications as well.

The problem with all of this fancy functionality is that when the battery of the smart watch is depleted, it simply stops working. Said differently, when the smart watch battery is depleted, the user is out of luck in that they have no access to any applications. If they would still like to be able to tell what the time of day is, that's just too bad. Need a stopwatch? You are simply out of luck.

Embodiments of the present application provide a solution to this dilemma by providing a low-power smart watch mode that delivers only basic functionality, such as the timekeeping function. In one embodiment, when an amount of stored energy falls below a predetermined threshold, one or more functions are disabled while the timekeeping function remains active. Advantageously, this transition allows a smart watch to keep performing like a conventional watch for a week or longer in this new low-power mode after—for all intents and purposes—the battery has died. In one embodiment, a small percentage of energy stored within the battery, e.g., ten percent of capacity, is reserved for this low-power mode.

In one embodiment, the disablement of functions includes switching from a high power consumption operating system, such as a real time operating system like Android.sup.™ OS, to a simpler operating system that performs only timekeeping and associated functions and thus draws less power. In another embodiment, the disablement of functions includes placing an energy-hungry application processor into a sleep mode or turning it OFF altogether and switching to an auxiliary processor that consumes less power. In one embodiment, the auxiliary processors is a sensor hub-like processor that only performs the timekeeping function.

In one embodiment, when the predetermined threshold is reached, all wireless communication is terminated to conserve power. In one embodiment where the display of the smart watch is a touch-sensitive display, touch sensing can be terminated when operating in the low-power mode.

An objective of embodiments of the disclosure is to allow a smart watch to continue to operate as a conventional electronic watch for a minimum of one week on a single charge to improve the user experience. Accordingly, in on or more embodiments a user can charge a smart watch once and then wear it for a full week. The smart watch functions as a smart watch for a period of time, such as a day, and then seamlessly transitions into the low-power mode to function as a conventional electronic watch for another period of time, such as six days. In one or more embodiments, whether the smart watch should enter the low power mode when the amount of energy stored in the energy storage device falls to the predefined threshold is user selectable from a user interface. A user employs the user interface to “opt in” to the extended runtime feature.

In one embodiment, when the amount of energy stored in the energy storage device falls to the predetermined threshold, certain functions are disabled. For example, a function that keeps the display of the smart watch continuously ON can be disabled. As noted above, wireless communications with other electronic devices can be disabled. Audio voice control can be disabled, as can touch sensitivity of the display. In one embodiment, the “wake when the display is touched” function is also disabled.

In one embodiment, when the amount of energy stored in the energy storage device falls to the predetermined threshold the only function that remains active is the timekeeping function. In other embodiments, additional functions can remain active. For example, if the timekeeping function is active a user likely wants to be able to see the time on the display. Accordingly, in one or more embodiments gesture detection remains active so that when a user makes a gesture the time of day and/or date is presented on the display. In one embodiment, the user is still able to select how the time is presented, e.g., with an analog display, a digital display, or other display. In one embodiment local applications that function in response to only local user interface navigation, e.g., a settings application, still remain active. In one embodiment a user selection between low-power mode and normal mode is still active so that the user can return to the normal mode of operation. In one embodiment a pull-down display showing the battery meter and date is still available. In one embodiment, biometric sensors for measuring heart rate, number of steps taken, distance walked, and calories burned remains active. Such data could be synced with other devices after the energy storage device was recharged.

In one embodiment, a smart watch includes a watch casing and a display disposed along the watch casing. One or more processors, operable with the display, disposed are within the watch casing, as is an energy storage device to power the one or more processors. In one embodiment, the one or more processors are to, when an amount of stored energy in the energy storage device is above a predefined threshold, perform a timekeeping function and at least one additional function. However, when the amount of stored energy in the energy storage device falls below the predefined threshold, the one or more processors are to disable the at least one additional function while continuing to perform the timekeeping function. In one embodiment, the one or more processors are to disable the at least one additional function while continuing to perform the only timekeeping function. Other embodiments will be described in more detail below.

As noted above, smart watches offer added conveniences in comparison to smart phones or tablet computers due to the fact that they can be conveniently worn on the wrist. At the same time, embodiments of the disclosure contemplate that a smart watch with a discharged battery offers absolutely no value to the user. Accordingly, when an amount of stored energy in a battery or other energy storage device is running low, embodiments of the disclosure allow the user the option to opt in—or cause the switch automatically—to a low-power mode in which a smart watch continues to perform at least a timekeeping function. This mode continues until the user can recharge the energy storage device.

Low-power modes can be configured in different ways in accordance with various embodiments of the disclosure. For example, a first low-power mode can be a “stretch” mode where a user needs to make it just a few more hours until a charging cycle can commence. In one or more embodiments in the stretch mode, when the amount of stored energy falls to a predefined threshold such as ten to fifteen percent, one or more processors of the device disable one or more non-timekeeping functions so that the overall device obtains an additional several hours of battery life. While some embodiments can disable all other functions aside from the timekeeping function, in the stretch mode some additional functions such as a biometric step counter may remain operational. Accordingly, when operating in the low-power stretch mode, a user is able to see the time of day at a glance for the hours that the smart watch is operational in the low-power mode. The low-power mode can then be automatically disabled when the smart watch is charged. Alternatively, the low-power mode can be disabled when the user disables it using the user interface.

In other embodiments, the user needs the smart watch to run for many days. In such a situation, the one or more processors disable all other functions aside from the timekeeping function, thereby operating in a “watch only” low-power mode. For instance, if a user is taking a business trip, and forgets a charger for the smart watch, the user may want to be able to at least use the device as a timekeeper for three, four, or five days. In such an embodiment, the user may manipulate the user interface of the device to manually enter the watch only low-power mode. Accordingly, the one or more processors then disable all functions other than timekeeping to provide the user with an additional forty-eight to seventy-two hours of run time. While operating in this mode, the user is able to see the time of day at a glance, but would not have access to other power-consuming functions such as voice activation. Like the stretch mode, the watch only mode can be disabled when the smart watch is coupled to a charger or, alternatively, when the user presses and holds a control button of the user interface to power OFF and ON the smart watch. While the stretch mode and the watch only mode are two possible modes of operation, other modes of operation will be obvious to those of ordinary skill in the art having the benefit of this disclosure.

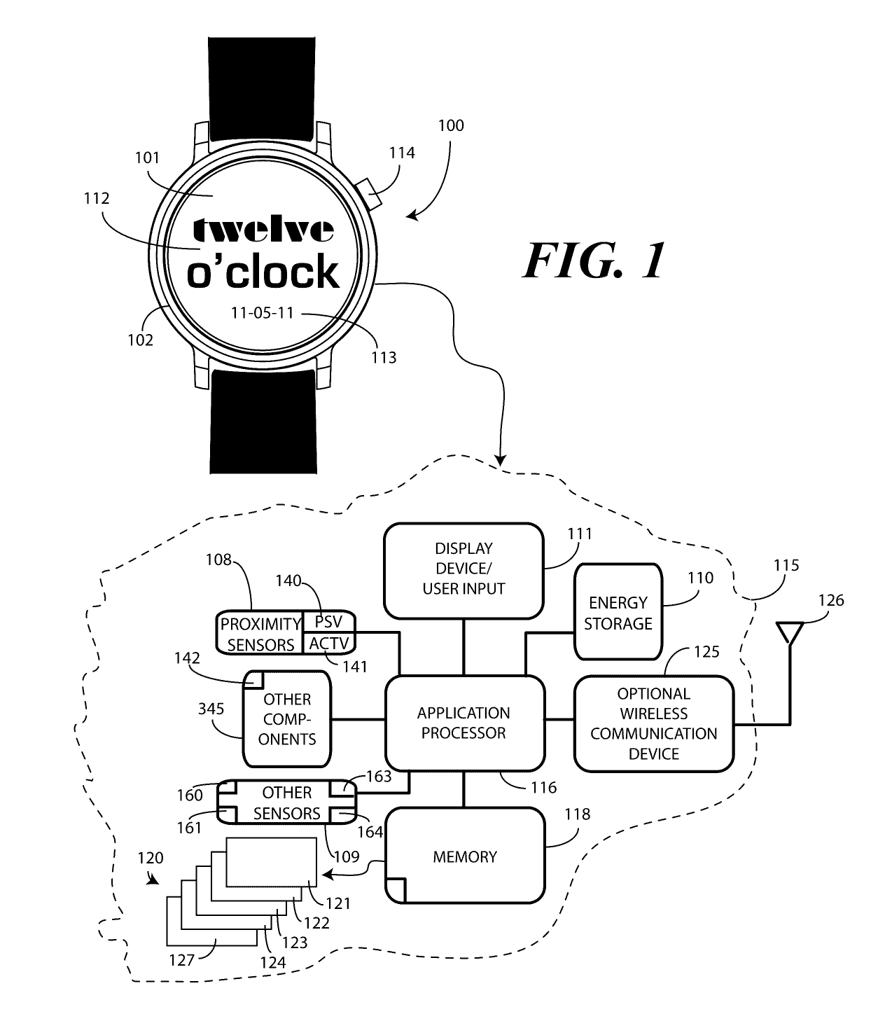

Turning now to FIG. 1, illustrated therein is one explanatory smart watch 100 in accordance with one or more embodiments of the disclosure. This illustrative smart watch 100 includes a display 102, which may optionally be touch-sensitive. In one embodiment where the display 102 is touch-sensitive, the display 102 can serve as a primary user interface of the smart watch 100. Users can deliver user input to the display 102 of such an embodiment by delivering touch input from a finger, stylus, or other objects disposed proximately with the display. In one embodiment, the display 102 is configured as a light emitting diode (LED) display. However, it should be noted that other types of displays would be obvious to those of ordinary skill in the art having the benefit of this disclosure.

The explanatory smart watch 100 of FIG. 1 also includes a watch casing 101. In one or more embodiments, the watch casing 101 is manufactured from a rigid material such as a rigid thermoplastic material, aluminum, steel, or another metal. Still other constructs will be obvious to those of ordinary skill in the art having the benefit of this disclosure.

The watch casing 101 can be formed from a single housing member or from multiple housing members. For example, the watch casing can include a front housing member disposed about the periphery of the display 102 and a rear-housing member defining the backside of the smart watch 100. In other embodiments, the watch casing 101 can simply be disposed about perimeter of a smart watch module that is inserted into watch casing 101. Features can be incorporated into the watch casing 101. Examples of such features include an optional speaker port, microphone port, or electrical connector to which a charger may be coupled. Alternatively, a user interface component, such as the control button 114 shown in FIG. 1, can be disposed along the watch casing 101.

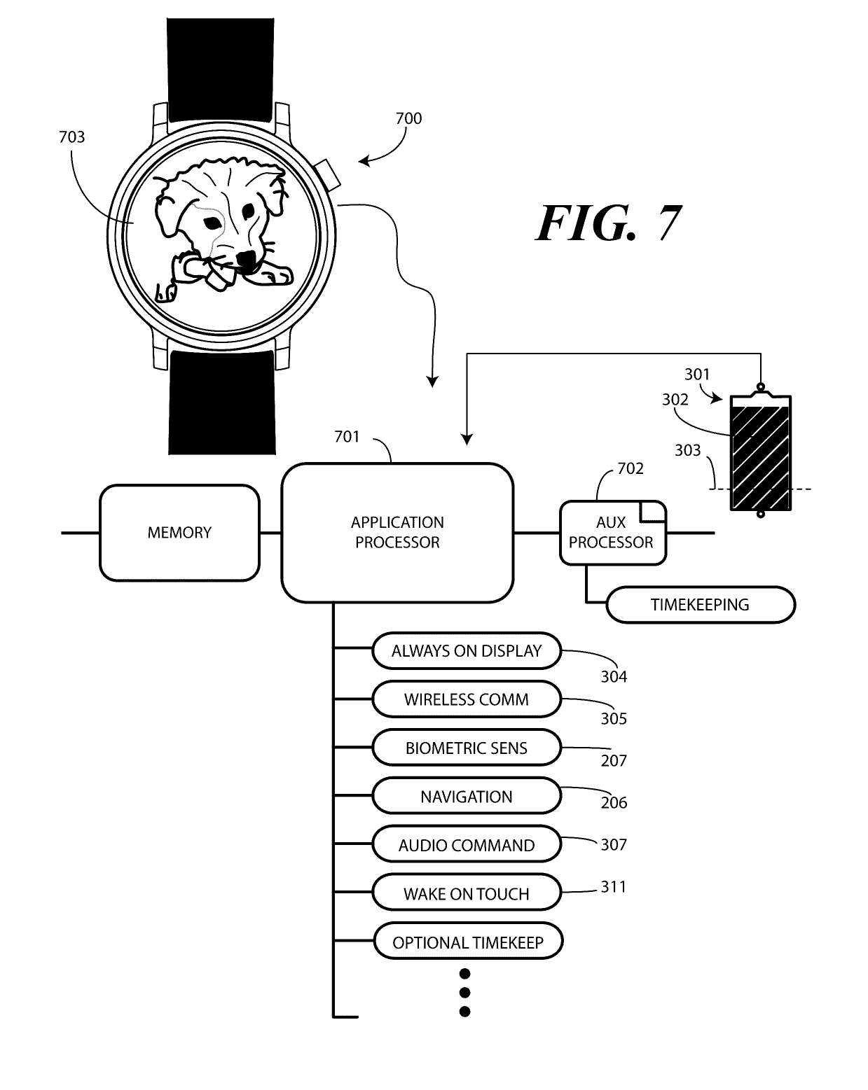

A block diagram schematic 115 of the smart watch 100 is also shown in FIG. 1. In one embodiment, the smart watch 100 includes one or more processors 116. The one or more processors 116 can be a single processor in one or more embodiments. Alternatively, as will be described in more detail with reference to FIG. 7 below, the one or more processors 116 can include an application processor and, optionally, one or more auxiliary processors. Moreover, one or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the smart watch 100. Each of the application processor and the auxiliary processor(s) can be configured to process and execute executable software code to perform the various functions of the smart watch 100. In one embodiment, the auxiliary processor will be configured to perform fewer functions, and thus consume less power from an energy storage device 110, than does the application processor. A storage device, such as memory 118, can optionally store the executable software code used by the one or more processors 116 during operation.

In this illustrative embodiment, the smart watch 100 also includes a communication circuit 125 that can be configured for wired or wireless communication with one or more other devices or networks. The networks can include a wide area network, a local area network, and/or personal area network. In one or more embodiments, the communication circuit 125 utilizes wireless technology for communication in peer-to-peer or ad hoc communications such as HomeRF, Bluetooth and IEEE 802.11 (a, b, g or n), and other forms of wireless communication such as infrared technology. The communication circuit 125 can include wireless communication circuitry, one of a receiver, a transmitter, or transceiver, and one or more antennas 126.

In one embodiment, the one or more processors 116 can be responsible for performing the primary functions of the smart watch 100. For example, in one embodiment the one or more processors 116 comprise one or more circuits operable with one or more user interface devices 111, which can include the display 102, to present presentation information, such as the time of day 112 or date 113, to a user.

The executable software code used by the one or more processors 116 can be configured as one or more modules 120 that are operable with the one or more processors 116. Such modules 120 can store instructions, control algorithms, logic steps, and so forth. In one embodiment, the one or more processors 116 are responsible for running the operating system environment 121. The operating system environment 121 can include a kernel 122 and one or more drivers, and an application service layer 123, and an application layer 124. The operating system environment 121 can be configured as executable code operating on one or more processors or control circuits of the smart watch 100.

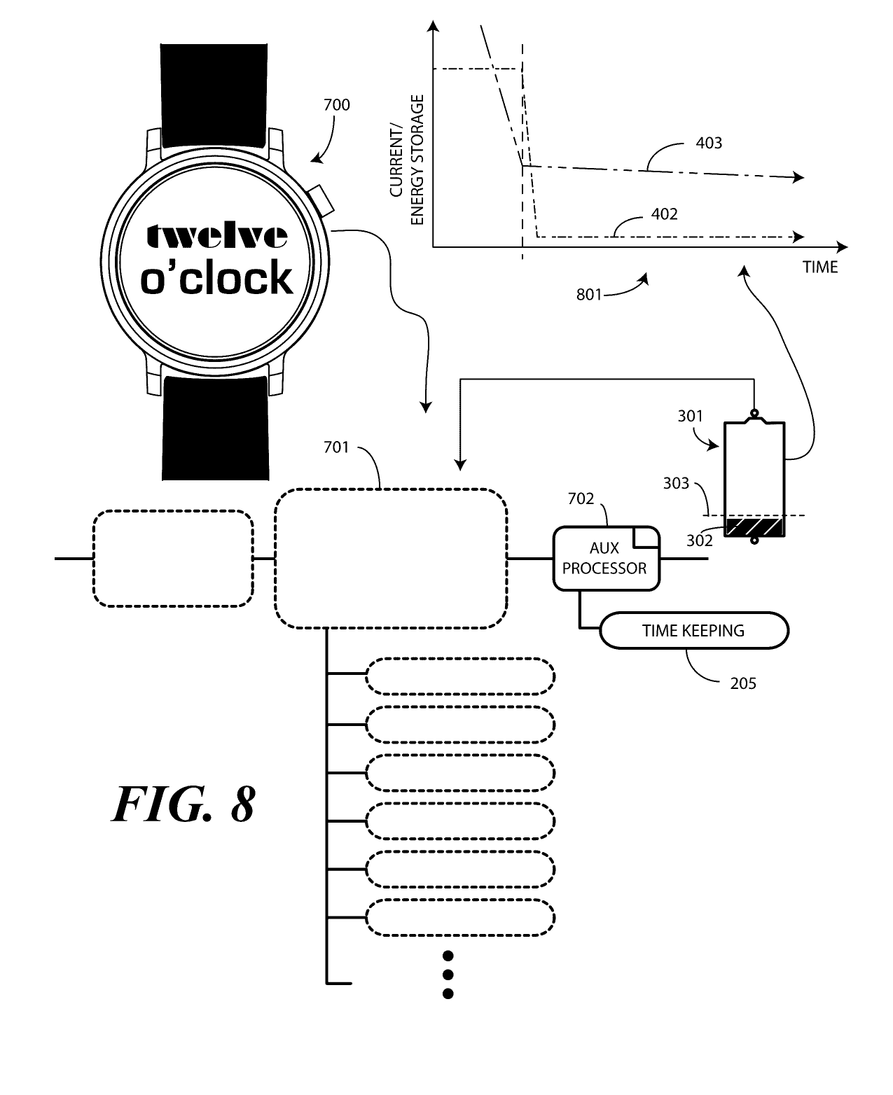

In one embodiment, the one or more modules 120 can comprise a dual operating system environment having a first operating system environment 121 and a second operating system environment 127. One example of this will be described in more detail below with reference to FIG. 8. In one embodiment, the second operating system environment 127 can be configured to perform fewer functions, and thus cause the one or more processors 116 to consume less power from an energy storage device 110, than the one or more processors 116 would if operating the primary operating system environment 121. Illustrating by example, the primary operating system environment 121 may be a Real Time Operating System environment, such as Android Wear.sup.™, while the second operating system environment that is a full direction operating system environment using a secured memory, while the second operating system environment 127 might be a fully contained, local memory, non-multi-threading operating system environment that is more efficient.

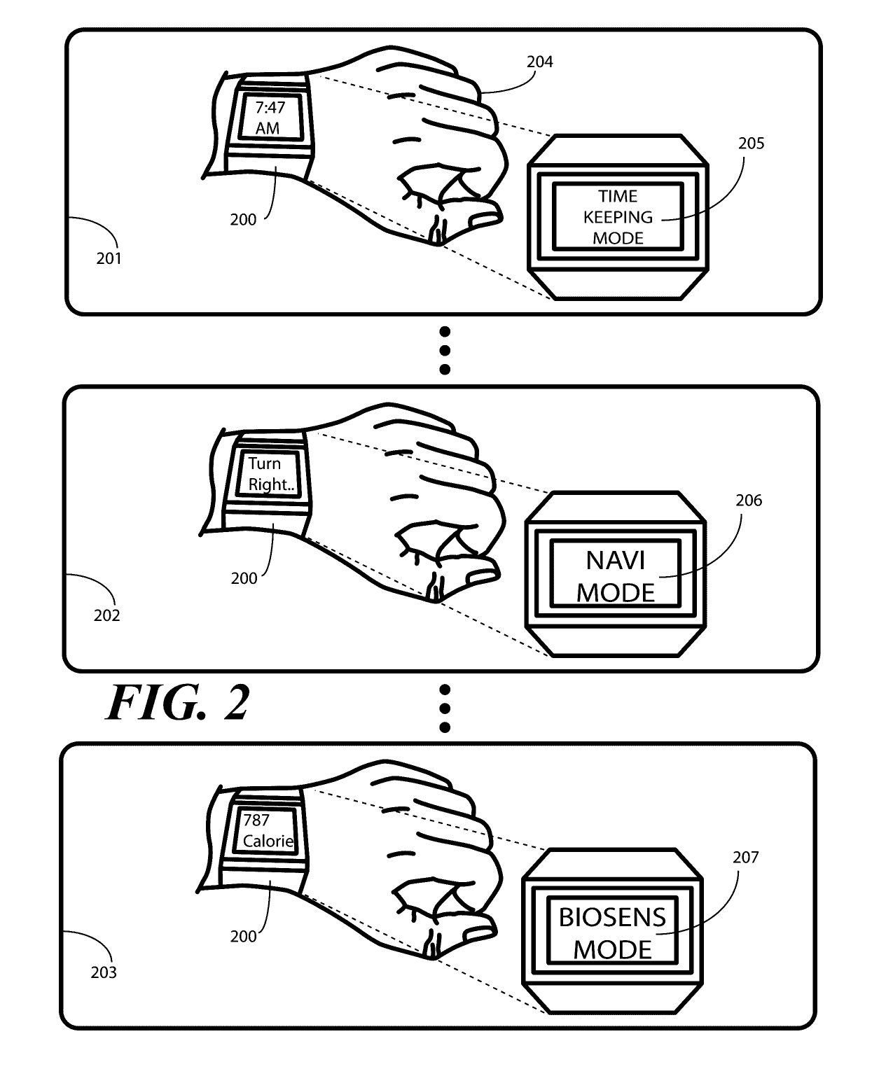

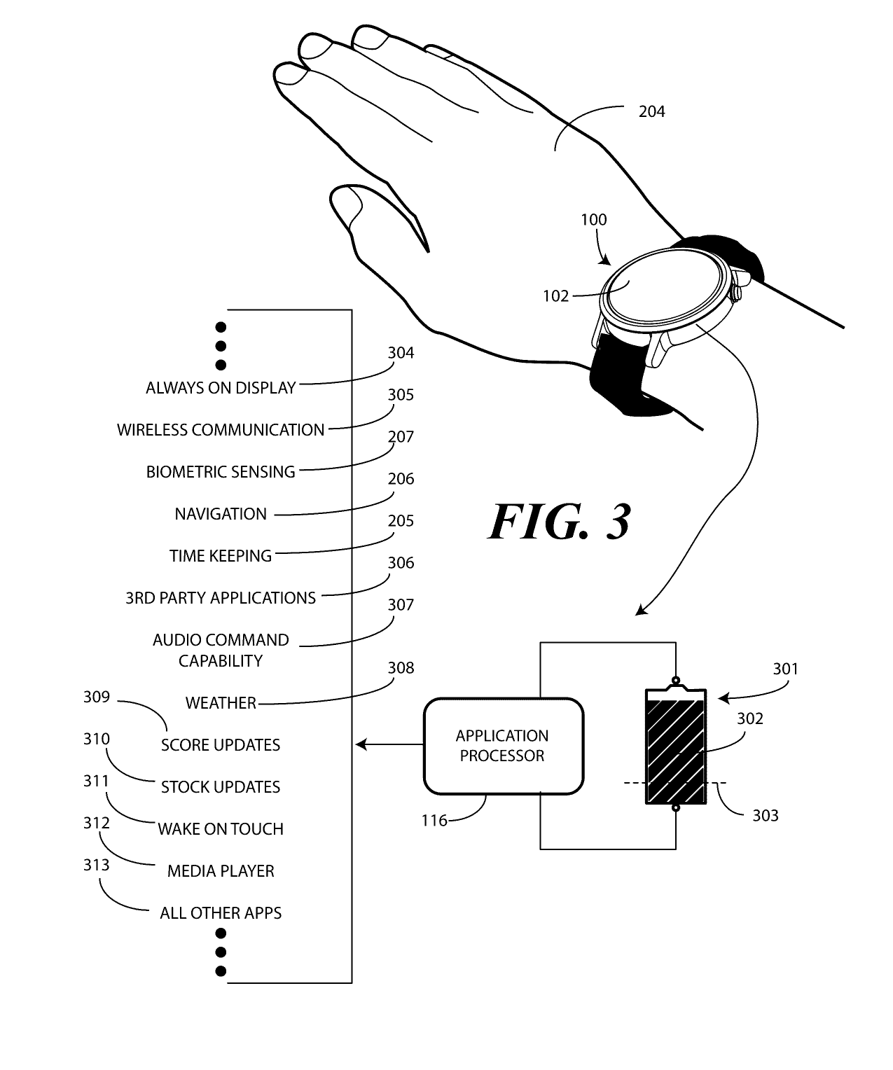

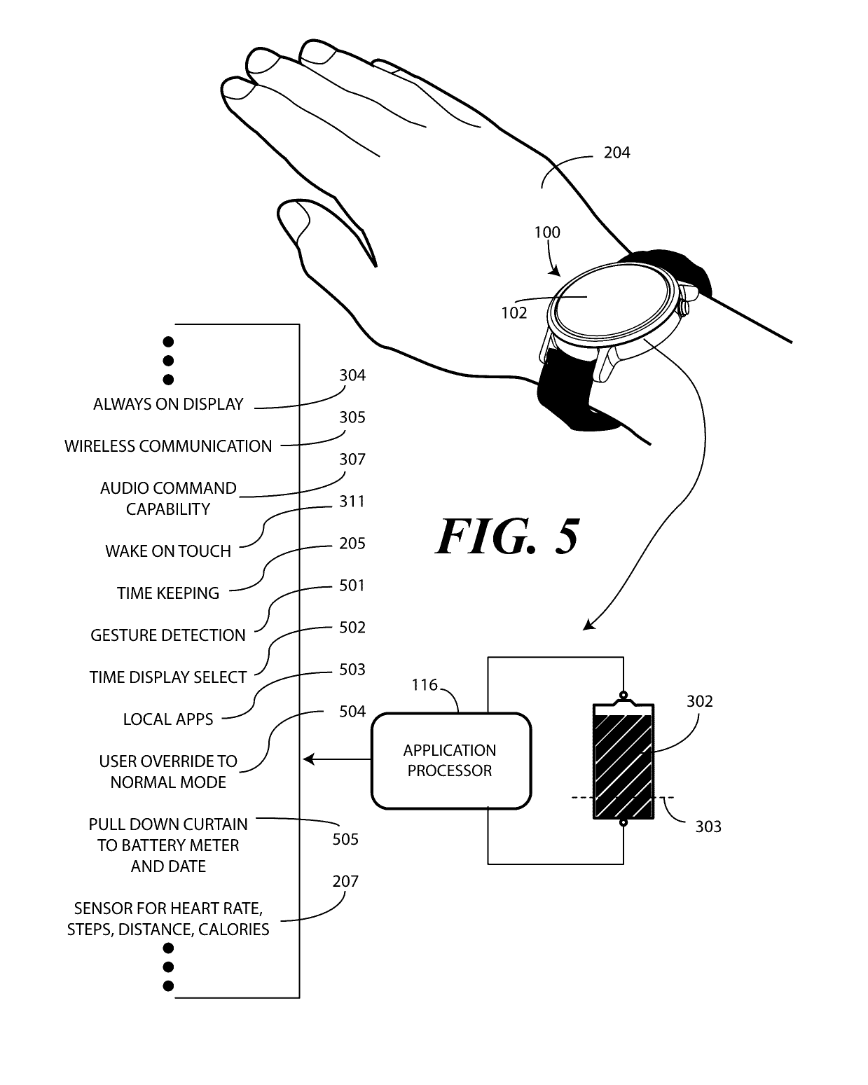

The application layer 124 can be responsible for executing application service modules. The application service modules may support one or more functions or applications or “apps.” Examples of such applications shown in FIG. 1 include a time of day application that presents the time of day 112 and/or date 113 on the display. Other explanatory applications or functions will be described below with reference to FIGS. 2-3, with even more functions or applications described below with reference to FIG. 5. Still other functions or applications will be obvious to one of ordinary skill in the art having the benefit of this disclosure. The applications of the application layer 124 can be configured as clients of the application service layer 123 to communicate with services through application program interfaces (APIs), messages, events, or other inter-process communication interfaces. Where auxiliary processors are used, they can be used to execute input/output functions, actuate user feedback devices, and so forth.

In one embodiment, one or more proximity sensors 108 can be operable with the one or more processors 116. In one embodiment, the one or more proximity sensors 108 include one or more proximity sensor components 140. The proximity sensors 108 can also include one or more proximity detector components 141. In one embodiment, the proximity sensor components 140 comprise only signal receivers. By contrast, the proximity detector components 141 include a signal receiver and a corresponding signal transmitter.

While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments the proximity sensor components have a longer detection range than do the proximity detector components due to the fact that the proximity sensor components detect heat directly emanating from a person's body (as opposed to reflecting off the person's body) while the proximity detector components rely upon reflections of infrared light emitted from the signal transmitter. For example, the proximity sensor component may be able to detect a person's body heat from a distance of about ten feet, while the signal receiver of the proximity detector component may only be able to detect reflected signals from the transmitter at a distance of about one to two feet.

In one embodiment, the proximity sensor component 140 comprises an infrared signal receiver so as to be able to detect infrared emissions from a person. Accordingly, the proximity sensor component 140 requires no transmitter since objects disposed external to the housing deliver emissions that are received by the infrared receiver. As no transmitter is required, each proximity sensor component 140 can operate at a very low power level. Evaluations conducted show that a group of infrared signal receivers can operate with a total current drain of just a few microamps (˜10 microamps per sensor). By contrast, a proximity detector component 141, which includes a signal transmitter, may draw hundreds of microamps to a few milliamps.

In one embodiment, one or more proximity detector components 141 can each include a signal receiver and a corresponding signal transmitter. The signal transmitter can transmit a beam of infrared light that reflects from a nearby object and is received by a corresponding signal receiver. The proximity detector components 141 can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals. The reflected signals can also be used to receive user input from a user delivering touch or gesture input to the smart watch 100.

One or more other sensors 109 included in the smart watch 100 may include a microphone 160, a speaker 161, and alternatively an imager 163. The one or more other sensors 109 may also include key selection sensors, a touch pad sensor, a touch screen sensor, a capacitive touch sensor, and one or more switches. Touch sensors 155 may used to indicate whether any of the user actuation targets present on the display 102 are being actuated. Alternatively, touch sensors 155 disposed in the watch casing 101 can be used to determine whether the smart watch 100 is being touched at side edges or major faces of the smart watch 100 are being performed by a user. The touch sensors 155 can include surface and/or housing capacitive sensors in one embodiment. The other sensors 109 can also include audio sensors and video sensors (such as a camera).

The other components 145 of the smart watch 100 can also include motion detectors 142. For example, an accelerometer may be embedded in the electronic circuitry of the smart watch 100 to show vertical orientation, constant tilt and/or whether the smart watch 100 is stationary. The measurement of tilt relative to gravity is referred to as “static acceleration,” while the measurement of motion and/or vibration is referred to as “dynamic acceleration.” A gyroscope can be used in a similar fashion.

Regardless of the type of motion detectors 142 that are used, in one embodiment the motion detectors 142 are also operable to detect movement, and direction of movement, of the smart watch 100 by a user. In one or more embodiments, the other sensors 109 and the motion detectors 142 can each be used to detect motion corresponding to a user's body or to human motion. This information can be used to determine that the smart watch 100 is being worn on a user's wrist, for example, as well as to detect gesture movement.

Illustrating by example, in one embodiment when the smart watch 100 is being worn on a wrist, the motion detectors 142 can be used to detect predefined motions corresponding to human motion. These predefined motions can be small, and can include vibration, shaking, breathing, micromotions, and so forth. For instance, if the user is walking, the motion detectors 142 can detect this movement by detecting motion of the user's wrist. The one or more processors 116 can then extract parametric data from electronic signals delivered by these motion detectors 142 in response to the user walking. By comparing the parametric data to a reference file stored in memory 118, the one or more processors 116 can identify the walking motion as corresponding to the motion of the user's body. The one or more processors 116 can use this information to distinguish the smart watch 100 being actively worn on a wrist, for example, as opposed to being placed along a flat surface such as a nightstand or dresser top. The motion detectors 142 can be used to detect other movement of the smart watch 100 as well. For example, in some embodiments a user can deliver gesture input by moving a hand or arm in predefined motions when the smart watch 100 is being worn on a wrist.

Many of the sensors in the smart watch 100 can be used to detect movement, gestures, or other user input. For example, the one or more proximity sensors 108 can detect the gesture of a user waving a hand above the display 102. In another embodiment, the user can deliver gesture input by touching the display 102. In yet another embodiment, the accelerometer 152 can detect gesture input from a user lifting, shaking, or otherwise deliberately moving the smart watch 100. In yet other embodiments, the user can deliver gesture input by rotating or changing the orientation of the smart watch 100, which can be detected by multiple accelerometers or a gyroscope. It should be clear to those of ordinary skill in the art having the benefit of this disclosure that additional sensors can be included with the other sensors 109 shown in FIG. 1.

Other components 145 operable with the one or more processors 116 can include output components such as video outputs, audio outputs, and/or mechanical outputs. Examples of output components include audio outputs, or other alarms and/or buzzers and/or a mechanical output component such as vibrating or motion-based mechanisms. Still other components will be obvious to those of ordinary skill in the art having the benefit of this disclosure.

An energy storage device 110, such as a rechargeable battery, super capacitor, or fuel cell, can be included in the smart watch 100 to power its various components. Where a rechargeable battery is used as the energy storage device 110, this battery can include a lithium ion cell or a nickel metal hydride cell. In one embodiment, the battery is a lithium polymer cell, as such cells having reasonably large energy density, wide operating temperature range, offer large number of charging cycles, and provide long useful life. The energy storage device 110 may also include overvoltage and overcurrent protection and charging circuitry. In one embodiment, the energy storage device 110 is a 350 mAh lithium polymer cell.

It is to be understood that FIG. 1 is provided for illustrative purposes only and for illustrating components of one smart watch 100 in accordance with embodiments of the disclosure, and is not intended to be a complete schematic diagram of the various components required for an electronic device. Therefore, other electronic devices in accordance with embodiments of the disclosure may include various other components not shown in FIG. 1, or may include a combination of two or more components or a division of a particular component into two or more separate components, and still be within the scope of the present disclosure.

Recall from above that the application layer 124 can be responsible for executing application service modules to provide specific features and/or outputs to a user on the display 102. The application service modules may support one or more functions or applications or “apps.” Turning now to FIG. 2, illustrated therein are three different functions or apps operable with the application service modules running on the application layer 124.

Beginning with function 201, here a user 204 is shown wearing a smart watch 200 in accordance with one or more embodiments of the disclosure on their wrist. As shown in the exploded view, the one or more processors of the smart watch 200 are performing a timekeeping function 205. When the one or more processors are running the timekeeping function 205, the user can see time of day and/or the date on the display. Optionally, the timekeeping function 205 can include other time-related effects, including a stopwatch simulation, a timer simulation, and an alarm simulation. In one or more embodiments the timekeeping function 205 also includes the capability to present the time of day (112) and/or date (113) on the display of the smart watch 200 as well. Other functions that can be provided in a timekeeping function 205 will be obvious to those of ordinary skill in the art having the benefit of this disclosure.

At function 202, the one or more processors of the smart watch 200 are performing a navigation function 206. When performing the navigation function 206, one or more processors of the smart watch can receive location information through a wireless communication circuit to determine a current location. The one or more processors can then determine a plurality of navigation routes between a current location and a user-defined destination by accessing map information. The map information can be stored locally or retrieved through a wireless communication circuit from a remote server across a network. The map information can include, but is not limited to, digital road map data, route alternatives, route guidance, route algorithms, route storing algorithms, map databases having distributed map database and traffic databases, and the like. Based upon this map information, the one or more processors of the smart watch 200 can then deliver navigational directions to a user through the output devices.

At function 203, the one or more processors of the smart watch 200 are performing a biometric sensor function 207. The biometric sensor function 207 can perform different and varied wellness functions in a health-monitoring mode. For example, a heart monitor can monitor a user's heart rate. A temperature monitor can be configured to monitor the temperature of a user. A pulse monitor can be configured to monitor the user's pulse. The pulse monitor lends itself to the wristwatch configuration of the smart watch 200 because the wrist serves as an advantageous location from which to measure a person's pulse.

Similarly, a moisture detector can be configured to detect the amount of moisture present on a person's skin. The moisture detector can be realized in the form of an impedance sensor that measures impedance between electrodes. As moisture can be due to external conditions, e.g., rain, or user conditions, perspiration, the moisture detector can function in tandem with ISFETS configured to measure pH or amounts of NaOH in the moisture or a galvanic sensor to determine not only the amount of moisture, but whether the moisture is due to external factors, perspiration, or combinations thereof.

The motion sensors of the smart watch 200 can be used to monitor user activity such as number of steps taken, distance, traveled, elevations climbed, and so forth. The history of this data, as well as the determinations made by the various wellness sensors, can be stored in a memory of the smart watch 200. The wellness sensors can be used to provide the user with a sensor-based health and wellness data assessment when the biometric sensor function 207 is active.

The functions 201, 202, 203 of FIG. 2 are illustrative only, and are intended to provide the reader with a few examples of various functions that can be operable in a smart watch 200 in accordance with one or more embodiments of the disclosure. Others will be described—more briefly—below with reference to FIGS. 3 and 5. Still others will be readily obvious to those of ordinary skill in the art having the benefit of this disclosure. In the embodiments that follow, while some functions will be shown in various embodiments, it should be noted that additional functions could be operable as well. Accordingly, any function sets shown in subsequent figures can be either full function sets or subsets of function sets.

Turning now to FIG. 3, illustrated therein is the smart watch 100 of FIG. 1. The energy storage device (110) is a rechargeable battery 301. The rechargeable battery 301 has an energy storage capacity, which in one embodiment is about 350 mAh. As used herein, the term “about” is used to refer to a measurement inclusive of manufacturing tolerances. Accordingly, a battery 301 with an energy storage capacity of 350 mAh with a tolerance of plus or minus 15 mAh would include those with storage capacities of between 335 mAh and 365 mAh, inclusive.

The one or more processors 116, operating in conjunction with energy management circuitry associated with the battery 301, can define a predefined threshold 303 of energy storage capacity upon which the smart watch 100 should transition to a low-power mode. In one or more embodiments, the predefined threshold 303 is user definable. For example, in one embodiment a user can deliver user input to a user interface (111) of the smart watch 100 to set the predefined threshold to, for example, five, ten, or fifteen percent. In one embodiment the predefined threshold is user definable along a range of zero and twenty-five percent, inclusive. In such an embodiment a user could effectively disable the low-power mode by setting the predetermined threshold to zero percent. In other embodiments, the one or more processors 116 may have stored in a memory (118) a default predefined threshold 303, such as ten percent or fifteen percent. This is but one example, as others will be obvious to those of ordinary skill in the art having the benefit of this disclosure.

As shown in FIG. 3, the one or more processors 116 can be configured to perform various functions. The illustrative functions of FIG. 3 include an always-on display function 304 that keeps the display 102 of the smart watch 100 on continuously so the user 204 can see it. Another function is a wireless communication function 305 where the smart watch 100 communicates via wireless communication with one or more other devices or networks, such as in peer-to-peer or ad hoc communications in HomeRF, Bluetooth.sup.™, or IEEE 802.11 (a, b, g or n) networks.

The functions can also include the biometric sensor function 207, the navigation function 206, or the timekeeping function 205 described above with reference to FIG. 2. The functions can further include various third party applications 306 that may be operable on the one or more processors 116. The functions can include an audio command capability function 307 by which the user 204 is able to deliver user input to the smart watch 100 by voice commands. The functions can include a weather function 308 by which a user receives weather updates, a score updates function 309 by which a user gets sporting scores, a stock update function 310 by which a user receives stock quotes, or other applications 313. In one embodiment, the functions include a wake on touch function 311 by which the one or more processors 116 are activated when the user 204 touches the display 102. The functions can also include a media player function 312 with which a user can play music or videos.

In one or more embodiments, when an amount of energy 302 stored in the battery 301 or other energy storage device (110) is above the predefined threshold 303, be it user defined or default, the one or more processors 116 are to perform the timekeeping function 205 and at least one additional function. In the embodiment of FIG. 3, this means that the one or more processors 116 can perform the timekeeping function 205 and any or all of the always-on display function 304, the wireless communication function 305, the biometric sensor function 207, the navigation function 206, the third party applications 306, the audio command capability function 307, the weather function 308, the score updates function 309, the stock update function 310, the wake on touch function 311, the media player function 312, or any other applications 313 operating on the smart watch 100.

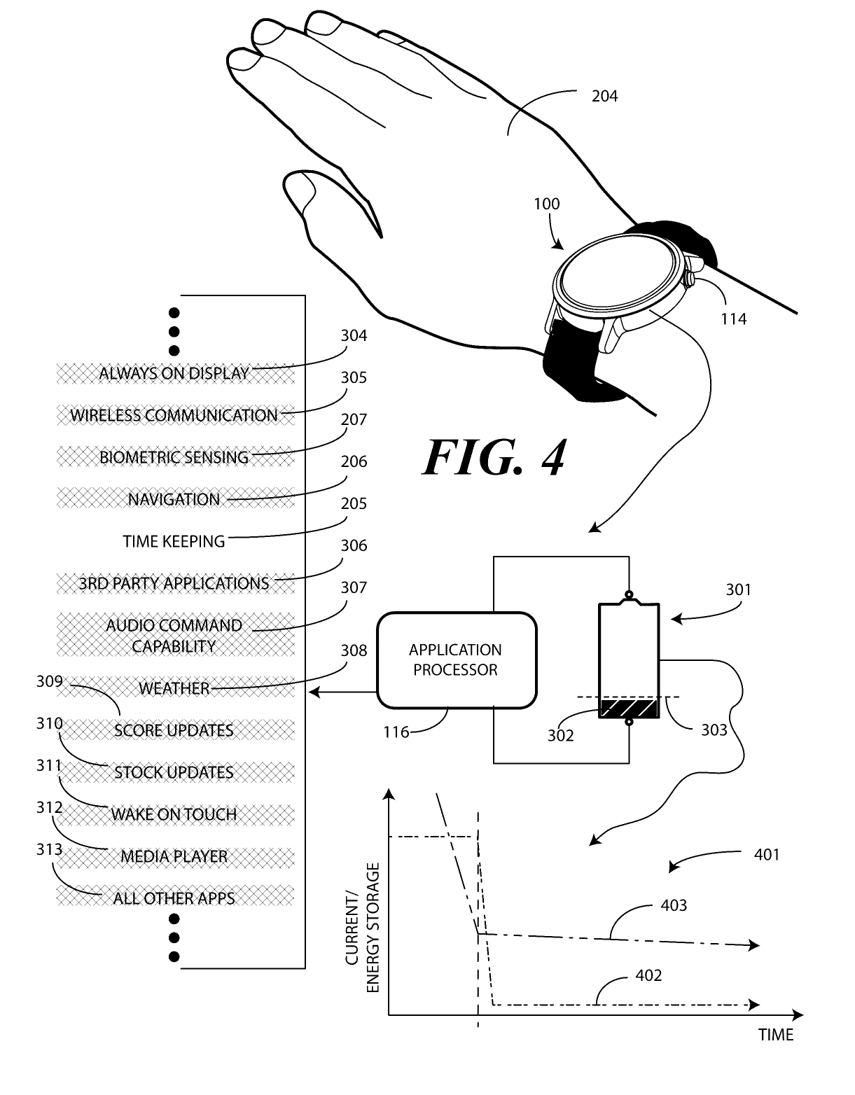

By contrast, turning now to FIG. 4, in one embodiment when the amount of energy 302 stored in the battery 301 or other energy storage device (110) falls below the predefined threshold 303, the one or more processors 116 of the smart watch 100 disable the at least one additional function while continuing to perform the timekeeping function 205. In the illustrative embodiment of FIG. 4, all additional functions have been disabled while only continuing to preform the timekeeping function 205. This means that each of the always-on display function 304, the wireless communication function 305, the biometric sensor function 207, the navigation function 206, the third party applications 306, the audio command capability function 307, the weather function 308, the score updates function 309, the stock update function 310, the wake on touch function 311, the media player function 312, or any other applications 313 operating on the smart watch 100 are disabled.

Recall from above that low-power modes in accordance with one or more embodiments of the disclosure can operate in a stretch mode or a watch only mode. The embodiment of FIG. 4 is the watch only mode that can be activated when the user 204 needs the smart watch 100 to run for many days. In such a situation, the one or more processors 116 disable all other functions aside from the timekeeping function 205, thereby operating in a watch only low-power mode. As shown at graph 401, this significantly reduces current drain 402 and extends energy capacity 403 of the battery 301.

If the user 204 is taking a business trip and forgets a charger for the smart watch 100, the user 204 may want to be able to at least use the device as a timekeeper for three, four, or five days. Accordingly, the one or more processors 116 then disable all functions other than the timekeeping function 205 to provide the user 204 with an additional forty-eight to seventy-two hours of run time. While operating in this mode, the user 204 is able to see the time of day at a glance, but would not have access to other power-consuming functions such as the audio command capability function 307. This mode can be disabled when the smart watch 100 is coupled to a charger or, alternatively, when the user 204 presses and holds a control button 114 of the user interface (111) to power OFF and ON the smart watch 100.

Turning now to FIG. 5, illustrated therein is the smart watch 100 where the one or more processors 116 are performing a different set of functions. As noted above, any function sets shown herein can be either full function sets or subsets of function sets. The illustrative functions of FIG. 5 include the always-on display function 304 that keeps the display 102 of the smart watch 100 on continuously so the user 204 can see it, the wireless communication function 305 where the smart watch 100 communicates via wireless communication with one or more other devices or networks, the audio command capability function 307 by which the user 204 is able to deliver user input to the smart watch 100 by voice commands, the wake on touch function 311 by which the one or more processors 116 are activated when the user 204 touches the display 102, and the timekeeping function 205.

Other functions of FIG. 5 include a gesture detection function 501 where the motion detectors (142) and other sensors (109) are also operable to detect movement, and direction of movement, of the smart watch 100 by the user 204 to detect gesture movement. A time display select function 502 allows the user 204 to select how to view the time of day (112) on the display 102, e.g., digitally, by an analog readout, or by text. Local applications 503 that can remain functional with user manipulation of the user interface (111) without the wireless communication function (305) are operable. A user override to normal mode function 504 is operable so that the user 204 can revert the smart watch 100 to normal mode operation even when the amount of energy 302 falls below the predefined threshold 303. A pull down curtain function 505 allows the user 204 to manipulate the display 102 of the smart watch to activate a screen that presents a battery meter display and/or a date (113). The biometric sensor function 207 is also active.

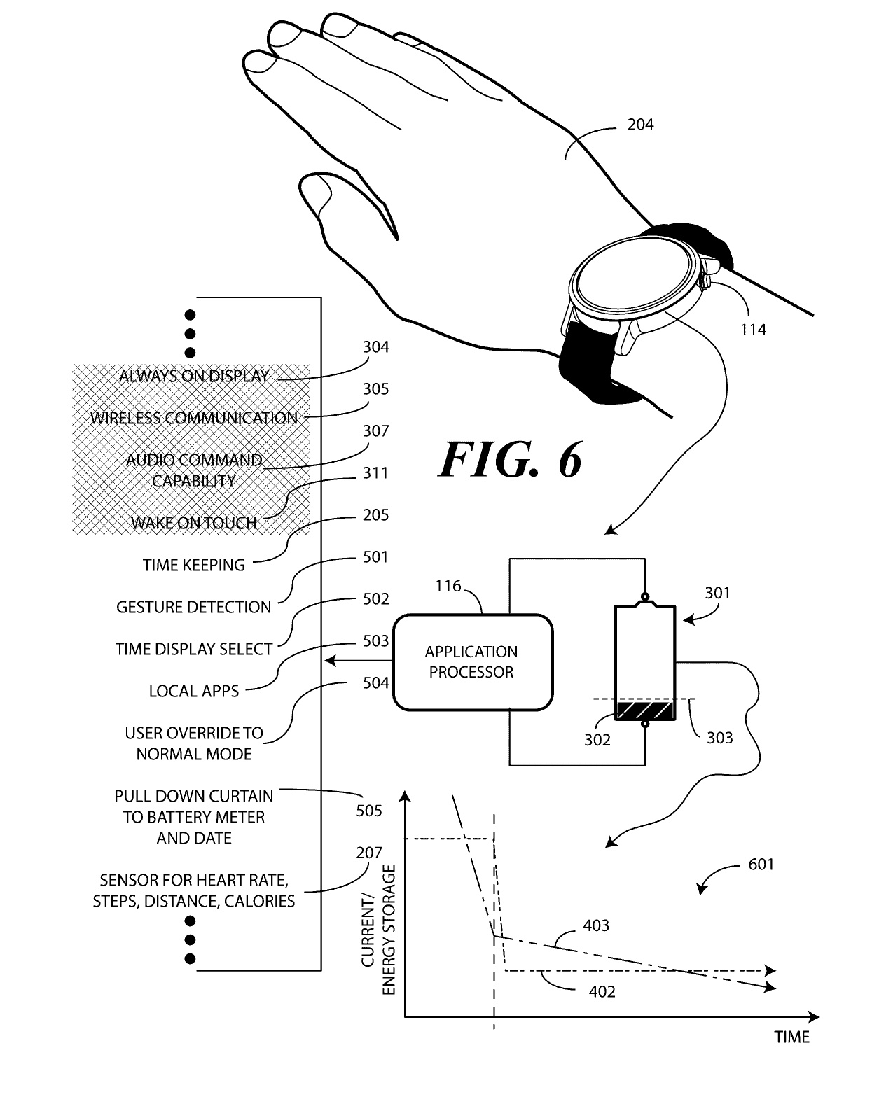

Turning now to FIG. 6, recall from above that in addition to the watch only mode, the smart watch 100 can operate in a stretch mode where the user 204 needs to make it just a few more hours until a charging cycle can commence. Such a mode is shown in FIG. 6 where, when the amount of energy 302 stored in the battery 301 falls below the predefined threshold 303, the one or more processors 116 disable one or more non-timekeeping functions while some additional functions.

Thus, as shown in FIG. 5, the one or more processors 116 are configured to perform the timekeeping function 205 and at least one additional function, which in this case includes the always-on display function 304, the wireless communication function 305, the wake on touch function 311, and the timekeeping function 205. In this embodiment, the one or more processors 116 also perform at least a third function, which in this case includes the gesture detection function 501, the time display select function 502, the local applications 503, the user override to normal mode function 504, the pull down curtain function 505, and the biometric sensor function 207.

In one embodiment, when the amount of energy 302 stored in the battery 301 or other energy storage device (110) is above the predefined threshold 303, the one or more processors 116 perform the timekeeping function, the at least one additional function, and the at least a third function. This was the case in FIG. 5. However, as shown in FIG. 6, in one embodiment, when the amount of energy 302 in the battery 301 or other energy storage device (110) falls below the predefined threshold 303, the one or more processors 116 disable the at least one additional function while continuing to perform the timekeeping function 205 and the at least a third function. This means that the always-on display function 304, the wireless communication function 305, the wake on touch function 311, and the timekeeping function 205 are disabled, while the gesture detection function 501, the time display select function 502, the local applications 503, the user override to normal mode function 504, the pull down curtain function 505, and the biometric sensor function 207 all remain active. Other configurations will be obvious to those of ordinary skill in the art having the benefit of this disclosure.

As shown at graph 601, current drain 402 is not reduced as much as with the watch only mode of FIG. 4. However, the reduction obtained still extends the energy capacity 403 of the battery 301, thereby giving the user 204 a few more hours of run time until the battery 301 of the smart watch 100 can be recharged.

It should be noted that for either the watch only mode of FIG. 4 or the stretch mode of FIG. 6, the timekeeping function 205 remains active. In one or more embodiments, the timekeeping function 205 is configured to present at least the time of day (112) on the display 102 temporarily in response to user input. The user input can be actuation of a control button 114 in one embodiment. Alternatively, the user input could be gesture input detected by the gesture detection function 501. Accordingly, in one or more embodiments the smart watch 100 includes one or more of a mechanical control device, e.g., control button 114, or a motion detector (142), and the user input comprising one of actuation of the mechanical control device or detection of gesture input by the motion detector (142). Other suitable techniques for delivering user input to the smart watch 100 will be obvious to those of ordinary skill in the art having the benefit of this disclosure.

Turning now to FIG. 7, illustrated therein is another smart watch 700 configured in accordance with one or more embodiments of the disclosure. Recall from above that in one embodiment, the one or more processors include an application processor 701 and an auxiliary processor 702. The application processor 701 serves as a first processor of the smart watch 700, while the auxiliary processor 702 serves as a second processor.

In one embodiment the application processor 701 is a high-power processors capable of performing many functions and capable of running complex operating systems. By contrast, the auxiliary processor 702 is a low-power device capable of performing only a few functions. In the illustrative embodiment of FIG. 7 for example, the application processor 701 performs function such as the always-on display function 304, the wireless communication function 305, the biometric sensor function 207, the navigation function 206, the audio command capability function 307, the wake on touch function 311, and other functions. By contrast, the auxiliary processor 702 performs only the timekeeping function 205, which includes the ability to determine the time of day (112), optionally the date (113, and present at least the time of day (112) on the display 703 of the smart watch 700 in one or more embodiments. The auxiliary processor 702 may optionally be operable with non-secure function circuitry (not shown) to control one or more functions, including actuation of the display 703, actuation of an audio output, actuation of a haptic or tactile output that a user can feel, or actuation of another function. Alternatively, the auxiliary processor 702 may actuate or control the one or more functions directly in other embodiments.

In one embodiment, the application processor 701 is responsible for performing the primary functions of the smart watch 700. In one embodiment, the application processor 701 is responsible for running the operating system environment. In one or more embodiments, the application processor 701 is responsible for managing the applications other than the timekeeping function 705 and associated display presentation functions, and handles all secure information of the smart watch 700. The application processor 701 can be also responsible for launching, monitoring and killing the various applications and the various application service modules.

In one or more embodiments, as it tasked with many more operations to manage, the application processor 701 consumes more power than does the auxiliary processor 702 on an average basis when operating normally under an average load. For example, in ordinary operation the application processor 701 may consume on the order of milliwatts when running applications or communicating voice or other data, while the auxiliary processor 702 may only consume on the order of microwatts in its normal operation. Accordingly, in one or more embodiments the auxiliary processor 702 will consume less power than the application processor 701 when operational. In some situations, the application processor 901 can consume an order or magnitude or more power than the auxiliary processor 702.

When using an application processor 701 and an auxiliary processor 702, the auxiliary processor 702 can maintain the time of day while the application processor 901 remains in a low power or sleep mode. As the auxiliary processor 702 is a lower power processor, and is keeping track of time, it can allow the application processor 901 to remain in the low power or sleep mode when the amount of energy 302 stored in the battery 301 is below the predefined threshold 303.

In FIG. 7, the amount of energy 302 stored in the battery 301 is above the predefined threshold 303. Accordingly, the application processor 701 and the auxiliary processor 702 are both operational. However, turning now to FIG. 8, in one embodiment when the amount of energy 302 stored in the battery 301 or other energy storage device (110) falls below the predefined threshold 303, and the at least one additional function is disabled while continuing to perform the timekeeping function 205, this occurs by transforming the application processor 701 from active mode of operation (shown in FIG. 7) to an inactive mode (shown in FIG. 8). Advantageously, one or more embodiments of the disclosure employ the auxiliary processor 702 to perform the timekeeping function 205 while leaving the application processor 701 in the low power or sleep mode. This solution works to conserve overall power usage in an smart watch 700 by utilizing the auxiliary processor 702 to provide contextual functionality while leaving the application processor 901 in a low power state. As shown at graph 801, this significantly reduces current drain 402 and extends energy capacity 403 of the battery 301.

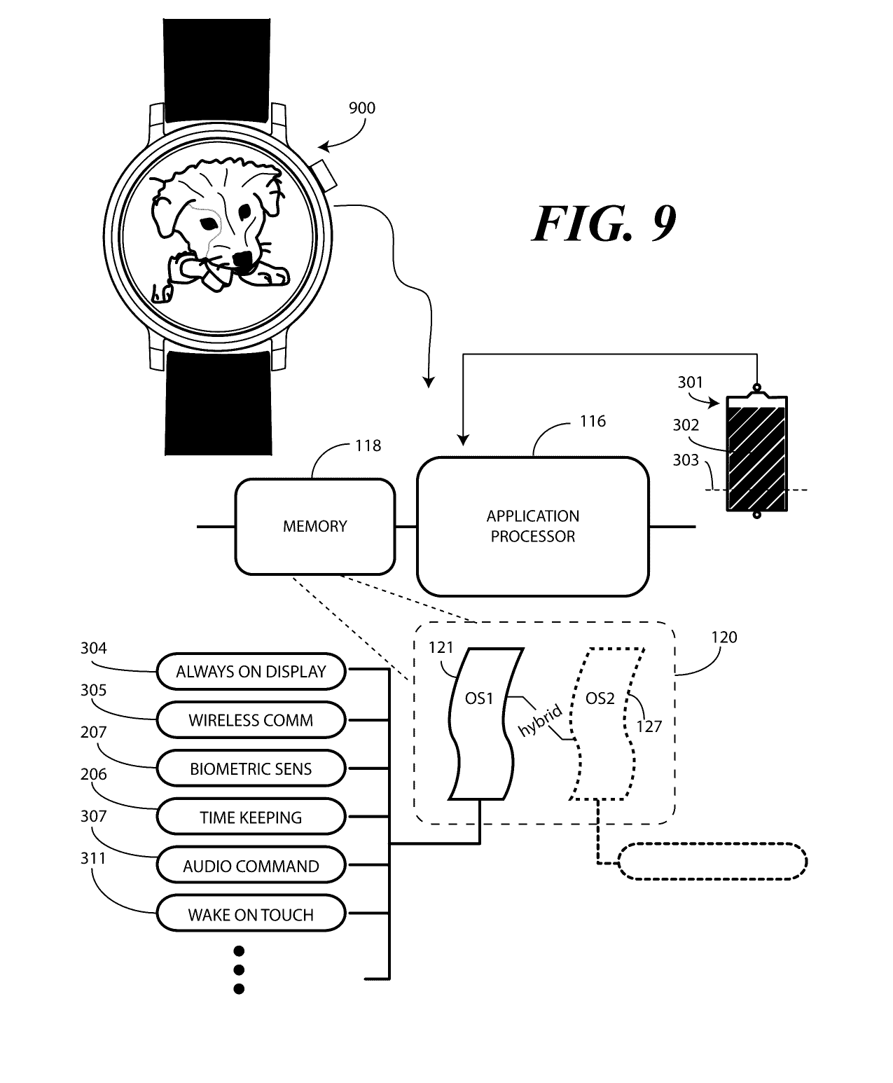

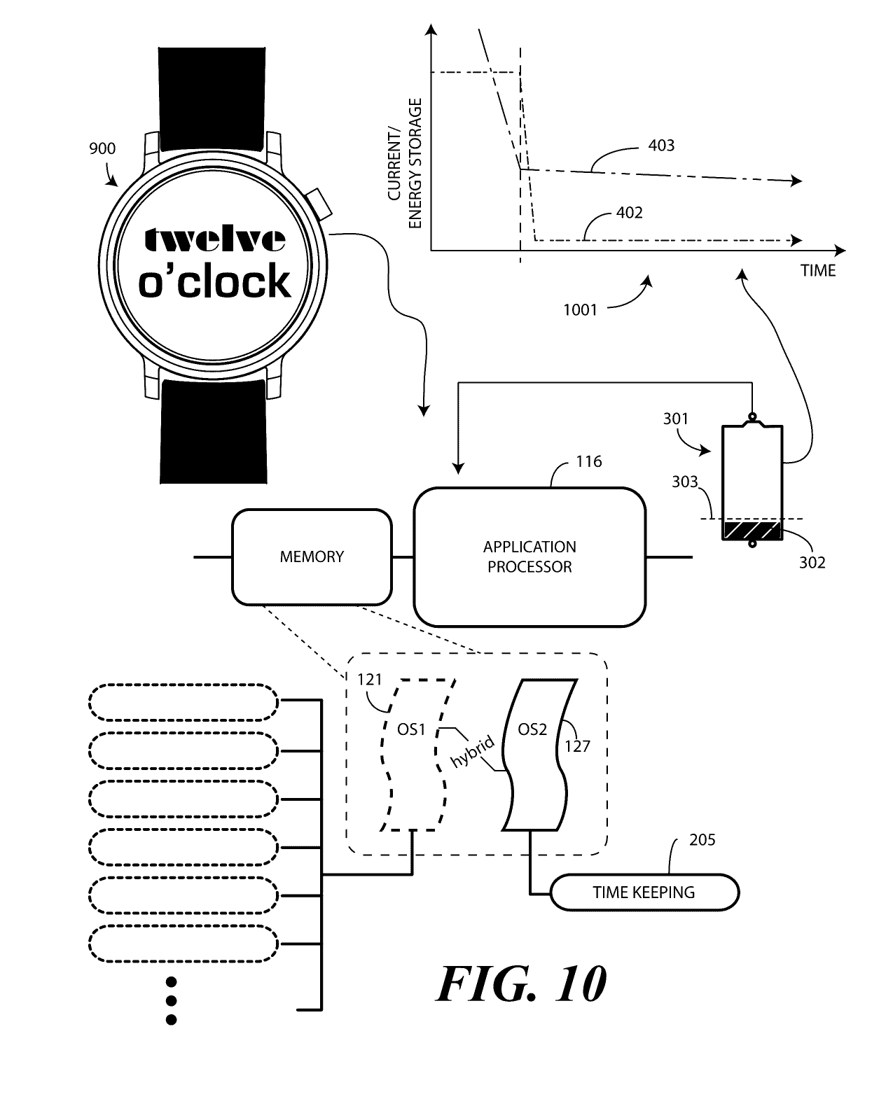

In another embodiment, rather than switching processors, a smart watch can switch operating systems to enter the stretch low-power mode or the watch only low-power mode. Turning now to FIGS. 9 and 10, illustrated therein is one such embodiment.

Beginning with FIG. 9, illustrated therein is another smart watch 900 configured in accordance with one or more embodiments of the disclosure. Recall from above that in one embodiment, one or more modules 120 stored in memory 118 can comprise a dual operating system environment having a first operating system environment 121 and a second operating system environment 127. In the illustrative embodiment of FIG. 9, the second operating system environment 127 can be configured to perform fewer functions, and thus cause the one or more processors 116 to consume less power from an energy storage device (110) such as battery 301 than the one or more processors 116 would if operating the primary operating system environment 121. Illustrating by example, the primary operating system environment 121 may be a Real Time Operating System environment, such as Android Wear.sup.™, that is a full direction operating system environment using a secured memory, while the second operating system environment 127 might be a fully contained, local memory, non-multi-threading operating system environment that is more efficient.

In the illustrative embodiment of FIG. 9 for example, the primary operating system environment 121 performs function such as the always-on display function 304, the wireless communication function 305, the biometric sensor function 207, the navigation function 206, the audio command capability function 307, the wake on touch function 311, and other functions. The primary operating system environment 121 can also perform the timekeeping function 205 when active. However, the second operating system environment 127 performs only the timekeeping function 205, which includes the ability to determine the time of day (112), optionally the date (113, and present at least the time of day (112) on the display 703 of the smart watch 700 in one or more embodiments.

In one or more embodiments, as it tasked with many more operations to manage, the one or more processors 116 consume more power operating the primary operating system environment 121 on an average basis when operating normally under an average load than when operating the secondary operating system environment. In some situations, the one or more processors 116 can consume an order or magnitude or more power when operating the primary operating system environment 121 than when operating the second operating system environment 127.

In FIG. 9, the amount of energy 302 stored in the battery 301 is above the predefined threshold 303. Accordingly, the one or more processors 116 operate the primary operating system environment 121. However, turning now to FIG. 10, in one embodiment when the amount of energy 302 stored in the battery 301 or other energy storage device (110) falls below the predefined threshold 303, and the at least one additional function is disabled while continuing to perform the timekeeping function 205, this occurs by switching from the first operating system environment 121 of a multi-operating system environment to a second operating system environment 127 of the multi-operating system environment. Advantageously, the one or more processors 116 employ the second operating system environment 127 to perform the timekeeping function 205 to conserve overall power usage in the smart watch 900. As shown at graph 1001, this significantly reduces current drain 402 and extends energy capacity 403 of the battery 301.

It should be noted that while the embodiment of FIGS. 9 and 10 illustrates the primary operating system environment 121 and the second operating system environment 127 being executed by a common processor, i.e., one or more processors 116, embodiments of the disclosure are not so limited. In another embodiment, a first processor could execute the first operating system environment 121, while a second processor executes the second operating system environment 127. Accordingly, in one embodiment when the amount of energy 302 stored in the battery 301 or other energy storage device (110) falls below the predefined threshold 303, and the at least one additional function can be disabled while continuing to perform the timekeeping function 205. Where multiple processors are used, this can occur by switching from a first processor executing the first operating system environment 121 of a multi-operating system environment to a second processor executing the second operating system environment 127 of the multi-operating system environment. Other implementations will be obvious to those of ordinary skill in the art having the benefit of this disclosure.

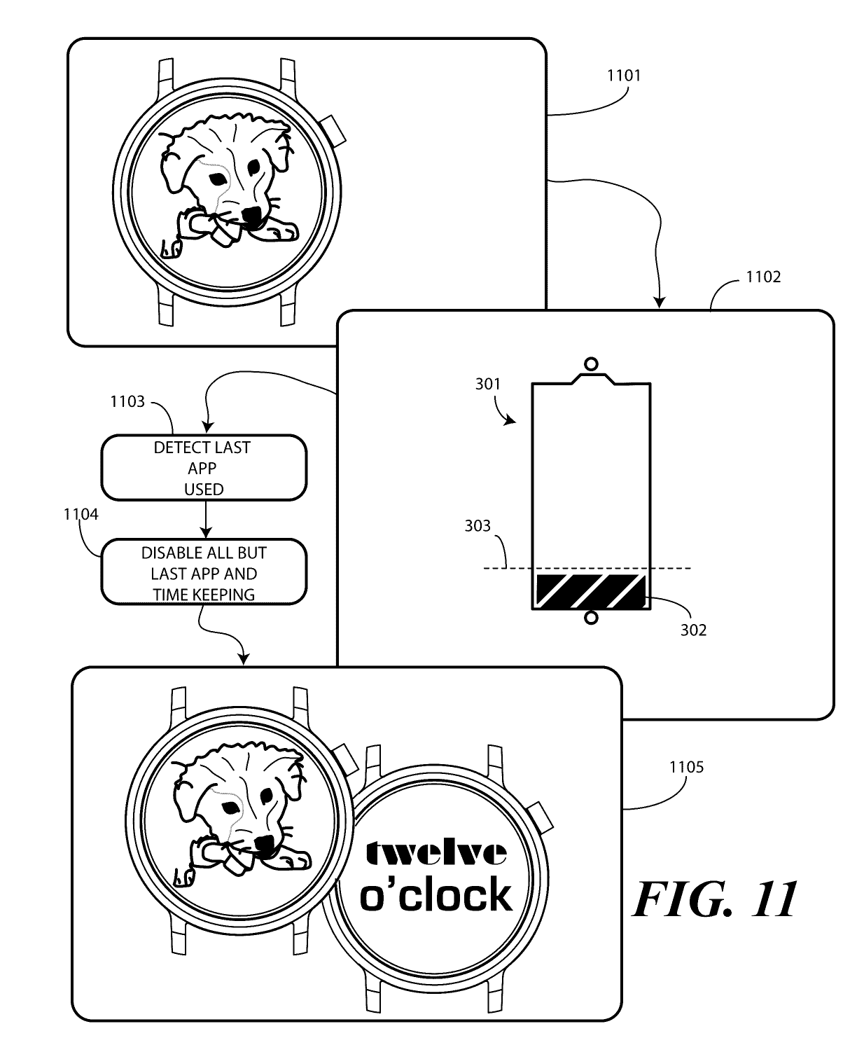

Recall from above that in the stretch mode of operation, a timekeeping feature and at least a third additional feature can remain operational after the amount of energy stored in an energy storage device falls below a predetermined threshold. In one or more embodiments, this additional third feature or features can be based upon usage of the device. Turning now to FIG. 11, illustrated therein is such a method of determining which function or application remains operational in addition to the timekeeping function once the amount of stored energy falls below the predetermined threshold.

Beginning at step 1101, a user is using a media browser function to look at a picture of their dog, Buster, on the display 102 of a smart watch 100. At step 1102, the amount of energy 302 stored in the battery 301 of the smart watch 100, or other energy storage device (110), falls below the predefined threshold 303. In one embodiment, this causes the smart watch 100 to enter the stretch low-power mode of operation.

However, before doing so, at step 1103 one or more processors (116) of the smart watch determine a last function or application used, which in this case is the media browser function. At step 1104, the one or more processors (116) disable at least one additional function, e.g., a wireless communication function (305). However, the one or more processors (116) continue to perform the timekeeping function and the at least a third function, i.e., the media browser function, as shown at step 1105. Accordingly, in one or more embodiments the at least a third function is selected from a plurality of functions based upon usage. A media browser function is just one example of a third function that could remain running. In another embodiment, the at least a third function can be a biometric function, a navigation function, or other function instead of the media browser function.

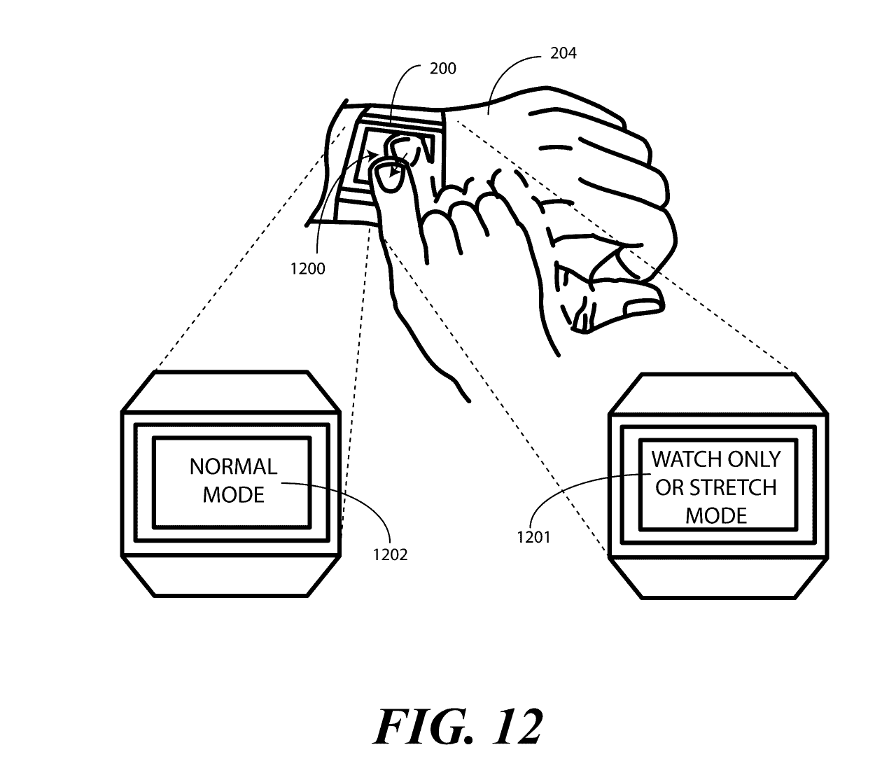

Recall from above that in some embodiments, the disablement of additional functions when the amount of energy 302 stored in the battery 301 of the smart watch 100, or other energy storage device (110), falls below the predefined threshold 303 occurs automatically. In other embodiments, a user opts in to the feature. Turning now to FIG. 12, it is shown that a user 204 can opt in to a low-power mode 1201 by delivering user input to a smart watch 200. Alternatively, the user 204 can opt out of the low-power mode 1201 by electing to stay in a normal mode 1202. In one embodiment, this can be done by setting the predefined threshold (303) to zero. Thus, in one embodiment the smart watch 200 includes a user interface where the the predefined threshold is user selectable by delivering user input 1200 to the user interface Alternatively, the user can simply turn the low-power mode 1201 OFF.

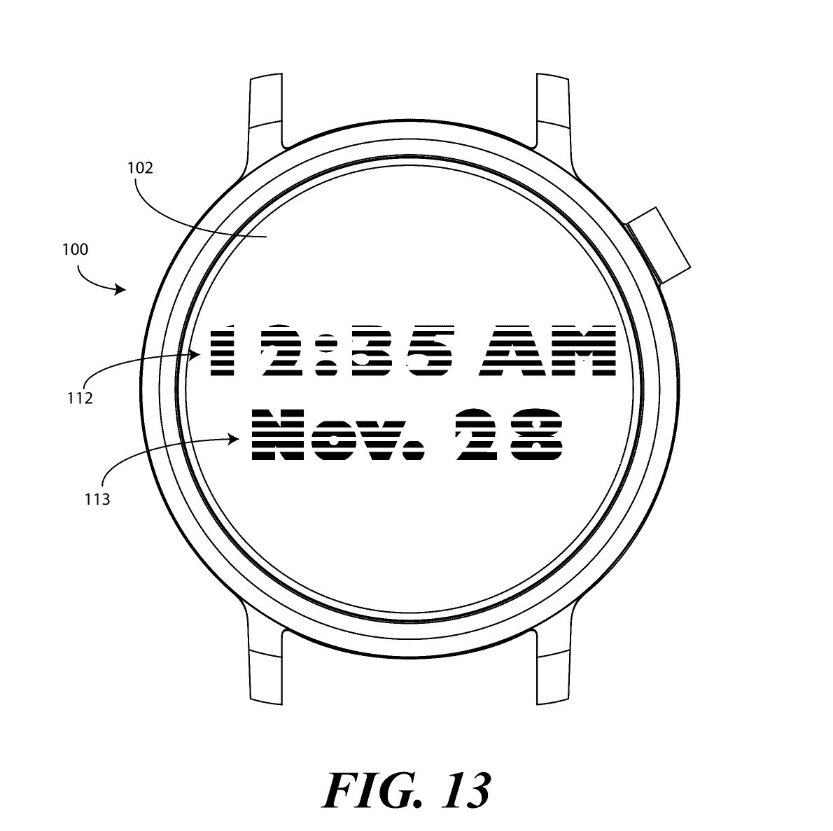

While switching processors or operating system environments are two ways of reducing power consumption, others are shown in FIG. 13. In one embodiment, the display 102 of a smart watch 100 is defined by a number of pixels. Power can be reduced by presenting the time of day 112 and/or date 113 only on a subportion of those pixels. Illustrating by example, in FIG. 13 the pixels of the display 102 are arranged in a plurality of interlaced illumination rows to present information on the display 102. In this illustrative embodiment, the timekeeping function (205) is configured to present the time of day 112 only on every other interlaced illumination row, i.e., on a subset of available pixels. Alternatively, the timekeeping function (205) could update a presentation of the time of day 112 on the display 102 at only periodic intervals. For example, rather than changing the time of day 112 every minute, it may only change the time of day 112 every five minutes. This is why the time of day 112 of FIG. 13 is a multiple of five.

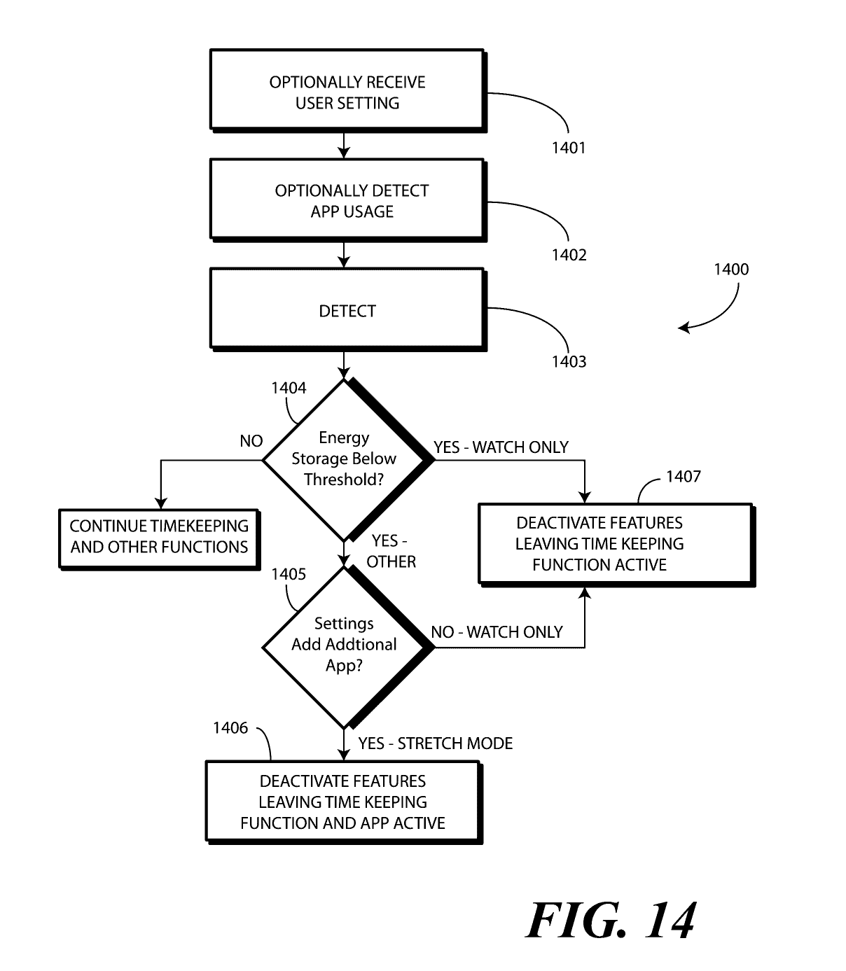

Turning now to FIG. 14, illustrated therein is a method 1400 for operating a smart watch in accordance with one or more embodiments of the disclosure. At step 1401, the method 1400 optionally receives a user setting determining whether a low-power mode should become operational when the amount of stored energy in an energy storage device falls below a predefined threshold. In one embodiment, this user input comprises an opt-in indication that the low-power mode should become operational when the amount of stored energy in the energy storage device falls below the predefined threshold.

At step 1402, the method 1400 can optionally detect past usage of the smart watch to determine which application to leave operational—in addition to the timekeeping function—when the amount of stored energy in the energy storage device falls below the predefined threshold. This step 1402 would be used in the stretch mode, but not in the time only mode.

At decision 1404, the method 1400 determines whether the amount of stored energy in the energy storage device falls below the predefined threshold. At decision 1405, the method 1400 determines, in one embodiment from step 1401, whether the low-power mode should be the stretch mode or the time only mode. Where it is the stretch mode, at step 1406 when the amount of stored energy in the energy storage device falls below the predefined threshold, the method 1400 disables at least one additional function while continuing to perform the timekeeping function and the at least a third function. However, where it is the time only mode, at step 1407 when the amount of stored energy in the energy storage device falls below the predefined threshold, the method 1400 disable the at least one additional function while continuing to perform only the timekeeping function. Said differently, in one embodiment at step 1407, the method 1400 continues performing only the timekeeping function while disabling all additional functions of the smart watch. Otherwise, the method 1400 performs a timekeeping function and at least one other function while an amount of stored energy in an energy storage device is above a predefined threshold as shown at step 1408.

Where optional step 1401 is omitted, either step 1406 or step 1407 would be performed automatically. Moreover, either step could be performed by placing at least one processor of multiple processors into a sleep mode as previously described. Alternatively, either step 1406 or step 1407 could occur by disabling an operating system of a multi-operating system environment. Other techniques could also be used, including presenting the time of day only on a subportion of the pixels of a display or by updating a presentation of the time of day on the display at only periodic intervals. Other power reduction techniques will be obvious to those of ordinary skill in the art having the benefit of this disclosure.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. A smart watch, comprising:
a watch casing;
a display disposed along the watch casing, the display comprising a plurality of pixels to present information on the display;
one or more processors, operable with the display, disposed within the watch casing; and
an energy storage device powering the one or more processors;
the one or more processors:
when an amount of stored energy in the energy storage device is above a predefined threshold, performing a timekeeping function and at least one additional function;
when the amount of stored energy in the energy storage device falls below the predefined threshold, disabling the at least one additional function while continuing to perform the timekeeping function; and
presenting the at least the time of day on only every other interlaced subset of the plurality of pixels.

2. The smart watch of claim 1, the one or more processors to, when the amount of stored energy in the energy storage device falls below the predefined threshold, disable the at least one additional function while continuing to perform only the timekeeping function.

3. The smart watch of claim 2, the predefined threshold comprising about ten percent of an energy storage capacity of the energy storage device.

4. The smart watch of claim 1, the at least one additional function comprising:
a first function operating the display in a continuously ON mode;
a second function to receive wireless communications from a remote device with a wireless communication circuit operable with the one or more processors;
a third function to receive voice input from a microphone operable with the one or more processors; and
a fourth function to receive touch input from a touch sensor operable with the one or more processors.

5. The smart watch of claim 1, the one or more processors comprising a first processor and a second processor, the first processor consuming more power from the energy storage device when in an active mode of operation than the second processor, wherein:
the first processor performs the at least one additional function;
the second processor performs the timekeeping function; and
the one or more processors disable the at least one additional function by transforming the first processor from the active mode of operation to an inactive mode.

6. The smart watch of claim 1, the one or more processors to disable the at least one additional function by switching from a first operating system of a multi-operating system environment to a second operating system of the multi-operating system environment.

7. The smart watch of claim 1, the smart watch further comprising a user interface, the predefined threshold user selectable by the user interface.

8. The smart watch of claim 7, the predefined threshold between zero and twenty-five percent, inclusive, of an energy storage capacity of the energy storage device.

9. The smart watch of claim 1, the timekeeping function to:
determine a time of day; and
present at least the time of day on the display.

10. The smart watch of claim 9, the timekeeping function to update a presentation of the at least the time of day on the display only at predetermined intervals.

11. The smart watch of claim 6, the first operating system comprising a real-time operating system and the second operating system comprising a fully contained, local memory, non-multi-threading operating system.

12. The smart watch of claim 9, the timekeeping function to present the at least the time of day on the display temporarily in response to user input, the smart watch comprising one or more of a mechanical control device or a motion sensor, the user input comprising one of actuation of the mechanical control device or detection of gesture input by the motion sensor.

13. The smart watch of claim 1, the one or more processors to:
when the amount of stored energy in the energy storage device is above the predefined threshold, perform:
the timekeeping function;
the at least one additional function; and
at least a third function; and
when the amount of stored energy in the energy storage device falls below the predefined threshold, disable the at least one additional function while continuing to perform the timekeeping function and the at least the third function.

14. The smart watch of claim 13, the at least the third function selected from a plurality of functions by most recent usage.

15. The smart watch of claim 13, the at least the third function comprising one of a biometric function or a navigation function.

16. A method of operating a smart watch, comprising:
performing, with one or more processors of the smart watch, a timekeeping function and at least one other function while an amount of stored energy in an energy storage device is above a predefined threshold; and
when the amount of stored energy in the energy storage device falls below the predefined threshold, disabling the at least one other function by disabling a first operating system of a multi-operating system environment, while continuing to perform the timekeeping function by switching from the first operating system to a second operating system, the second operating system configured to perform fewer functions than the first operating system environment.

17. The method of claim 16, the continuing performing only the timekeeping function while disabling all additional functions of the smart watch.

18. The method of claim 16, the disabling of the at least one other function occurring automatically when the amount of stored energy in the energy storage device falls below the predefined threshold.

19. The method of claim 16, the disabling comprising placing at least one processor of the one or more processors into a sleep mode.

20. The method of claim 16, the first operating system comprising a real-time operating system, and the second operating system comprising a full direction operating system.
